(19) United States
(12) Patent Application Publication
(10) Pub. No.: US 2019/0208046 A1
(43) Pub. Date: Jul. 4, 2019

(54) RING HOLDER/SUPPORT FOR PORTABLE DEVICES AND CARD HOLDERS AND METHOD

(71) Applicant: ROBERT GORDON INDUSTRIES, LTD., Lawrence, NY (US)

(72) Inventor: Robert GLUCK, New York, NY (US)

(73) Assignee: ROBERT GORDON INDUSTRIES, LTD., Lawrence, NY (US)

(21) Appl. No.: 16/225,818

(22) Filed: Dec. 19, 2018

Related U.S. Application Data
(60) Provisional application No. 62/611,908, filed on Dec. 29, 2017.

(51) Int. Cl. H04M 1/04; F16M 13/04

(52) U.S. Cl. CPC H04M 1/04; A45F 5/00; F16M 13/04

(57) ABSTRACT

Ring support/holder attachable to either a portable device or a card holder for a portable device. The support/holder includes a main attaching portion that utilizes an attachment surface, an outer circumferential surface, and an axial length that is less than a diameter of the outer circumferential surface. A ring is mounted to the main attaching portion and is capable of moving between a retracted position to an extended position. In the retracted position, an inner circumferential surface of the ring surrounds the outer circumferential surface. In the extended position, the inner circumferential surface does not surround the outer circumferential surface.

### CROSS-REFERENCE TO RELATED APPLICATIONS

The instant application claims priority under 35 U.S.C. § 119(e) of U.S. provisional Patent Application No. 62/611,908 filed on Dec. 29, 2017. The disclosure of which is expressly incorporated by reference herein in its entirety.

### BACKGROUND OF THE INVENTION

### 1. Field of the Invention

The present invention generally relates to ring holder/support that can be attached or is attachable to a portable device and/or to a card holder for a portable device such as a smart phone. The ring portion of the holder/support is configured to swing or pivot out from a retracted position and can function to allow a user to more safely or securely hold a portable device and/or may also serve as a portable device stand so as to support the portable device in an angle upright position.

### BACKGROUND OF THE INVENTION

### 2. Discussion of Background Information

Card holders are known and include those that attach to portable devices such as smart phones. The following US patents show examples of the same; the disclosures of which are incorporated by reference in their entireties; U.S. D738,619 to GLUCK and U.S. D745,278 to GLUCK. However, these devices have not addressed the problem of, among other things, making the portable device easier or safer to hold and/or do not serve to support the portable device in an angle upright position.

While advances have been made in improving or making improvements to card holders and more easy mounting of portable devices, there is a continuing need for more improvement which provides for additional advantages relating to ease of use, safety and reliability.

### SUMMARY OF THE INVENTION

According to one non-limiting embodiment of the invention, there is provided a ring holder/support that includes an attachable support which is securable to either a portable device or a card holder for a portable device. The attachable support may be attached to a front wall of a card holder while the back wall of the card holder is attached to a portable device. The card holder can be sized to hold one or more cards that may be a credit card, debit card, smart card, etc. The portable device may be a cell phone, smart phone, or other portable electronic device, etc.

In embodiments, the card holder is made of a synthetic resin.

In embodiments, the card holder is made of a silicone material.

In embodiments, the card holder further comprises an adhesive layer arranged on the back side.

In embodiments, the card holder further comprises a peel and stick adhesive sheet arranged on the back side.

The invention also provides for a ring support/holder attachable to either a portable device or a card holder for a portable device. The support/holder includes a main attaching portion that utilizes an attachment surface, an outer circumferential surface, and an axial length that is less than a diameter of the outer circumferential surface. A ring is mounted to the main attaching portion and is capable of moving between a retracted position to an extended position. In the retracted position, an inner circumferential surface of the ring surrounds the outer circumferential surface. In the extended position, the inner circumferential surface does not surround the outer circumferential surface.

In embodiments, the ring is swingably or pivotally mounted to the main attaching portion.

In embodiments, the ring is swingably or pivotally mounted to the main attaching portion via a pin.

In embodiments, the ring is made of metal.

In embodiments, the main attaching portion is made of metal.

In embodiments, the attachment surface comprises an adhesive layer configured to secure the attachment surface to the card holder or portable device.

In embodiments, the ring is circular and round in cross-section.

In embodiments, the main attaching portion is generally cylindrical.

In embodiments, the ring has an outer diameter of about 1 inch.

In embodiments, the ring has an inner diameter of about 0.75 inches.

In embodiments, the main attaching portion has an outer diameter of about 1 inch.

In embodiments, the invention also includes a ring holder attachable to either a portable device or a card holder for a portable device, said holder comprising a main cylindrical attaching portion comprising a planar attachment surface, an outer circumferential surface, and an axial length that is less than a diameter of the outer circumferential surface. A ring is pivotally mounted to the main attaching portion and being capable of moving between a retracted position where an inner circumferential surface of the ring surrounds the outer circumferential surface and a pivoted-out position.

In embodiments, the ring support/holder is attached to a front wall of the card holder.

In embodiments, the ring support/holder is attached to a rear side of the portable device.

In embodiments, the invention also provides for a ring holder attachable to a card holder for a portable device, said holder comprising a main cylindrical attaching portion comprising an attachment surface, an outer circumferential surface, and an axial length that is less than a diameter of the outer circumferential surface. A circular ring is swingable or pivotally mounted to the main attaching portion and being capable of moving between a retracted position where an inner circumferential surface of the ring surrounds the outer circumferential surface and a pivoted-out position.

In embodiments, the invention also provides for a ring holder configured to be attachable to a card holder, said holder comprising a main cylindrical attaching portion comprising an attachment surface, an outer circumferential surface, and an axial length that is less than a diameter of the outer circumferential surface. A circular ring is swingable or pivotally mounted to the main attaching portion and being capable of moving between a retracted position and a pivoted-out position. In the retracted position, an inner circumferential surface of the ring surrounds the outer circumferential surface.

In embodiments, the axial length is about ¼ inches.

In embodiments, the axial length is less than ¼ inches.

In embodiments, the invention also provides for a method of making the ring holder/support of any one of the types described above, wherein the method comprises attaching the ring holder/support to either a card holder or a portable device.

In embodiments, the invention also provides for a method of using the ring holder/support of any one of the types described above, wherein the method comprises moving the ring of the ring holder/support from an extended position to an extended or pivot out position.

In embodiments, the invention provides for a method of making the ring holder/support and card holder of any one of types described herein, wherein the method comprises moulding/molding (molding, forming in a mold, injection molding, etc.,) the card holder and attaching the ring holder/support to the card holder.

In embodiments, the invention provides for a method of making the ring holder/support and the card holder of any one of the types described herein and assembly the same.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a prior art card holder with the inventive ring support/holder attached thereto. The ring is in a retracted or initial position;

FIG. 2 shows a front view of FIG. 1;

FIG. 3 shows a back view of FIG. 1;

FIG. 4 shows a right view of FIG. 1:

FIG. 5 shows a left view of FIG. 1;

FIG. 6 shows a top view of FIG. 1;

FIG. 7 shows a bottom view of FIG. 1;

FIG. 8 shows the ring support and card holder of FIG. 1 mounted to a portable device shown in broken lines;

FIG. 9 shows the ring support and card holder of FIG. 1 mounted to a portable device shown in broken lines and with the ring moved to a partially extended position;

FIG. 10 shows the ring support and card holder of FIG. 1 mounted to a portable device shown in broken lines and with the ring moved to a partially extended position and with the user passing a finger through the ring;

FIG. 11 shows a top view of the ring support in an uninstalled state and with the ring in a retracted position;

FIG. 12 shows a top view of the ring support in an uninstalled state and with the ring in 180 degree extended position;

FIG. 13 shows a side view of the ring support in a partially installed state and prior to a connecting disc being used to secure the attaching portion to a front wall of the card holder;

FIG. 14 shows a side view of the ring support in an installed state with the connecting disc securing the attaching portion to a front wall of the card holder and with the ring in an initial retracted position;

FIG. 15 shows a side view of the ring support in an installed state with the connecting disc securing the attaching portion to a front wall of the card holder and with the ring in a 90 degree extended position;

FIG. 16 shows a side view of the ring support in an installed state with the connecting disc securing the attaching portion to a front wall of the card holder and with the ring in a 180 degree extended position;

FIG. 17 shows an enlarged side view of the ring support in an installed state with the connecting disc securing the attaching portion to a front wall of the card holder and with the ring in a 90 degree extended position. This figure also shows how the mounting ring is mounted between retaining portions of the attaching portion;

FIG. 18 shows a cross-section of the ring support and shows how the inner circumferential surface can be a flat or straight annular surface;

FIG. 19 shows a front view of a prior art card holder prior to being mounted to a portable device; and

FIG. 20 shows a side view of a prior art card holder mounted to a portable device.

### DETAILED DESCRIPTION OF THE INVENTION

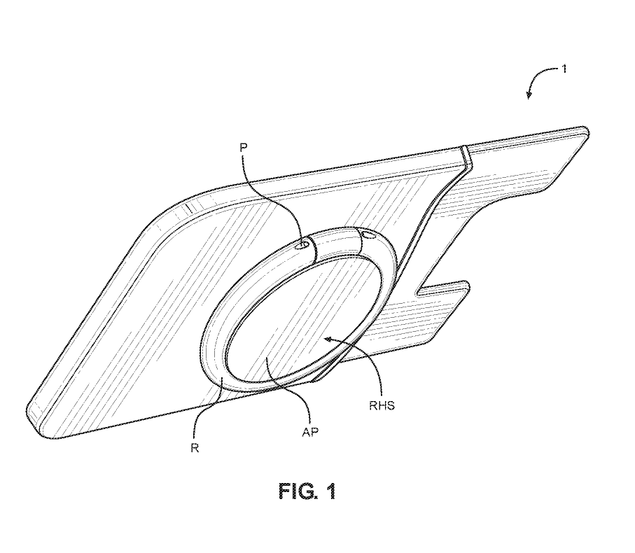

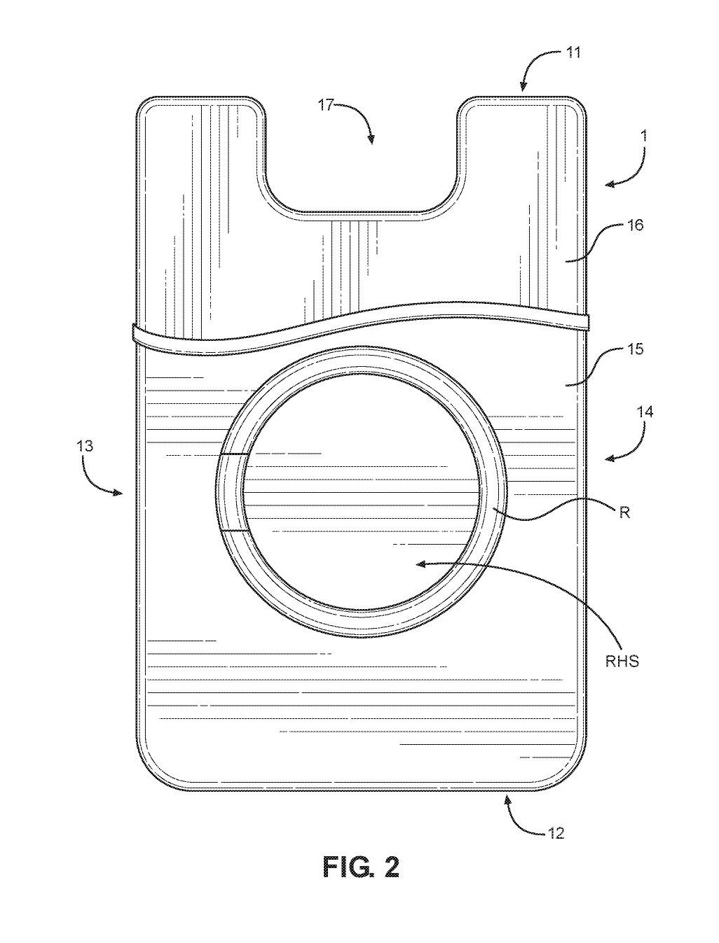

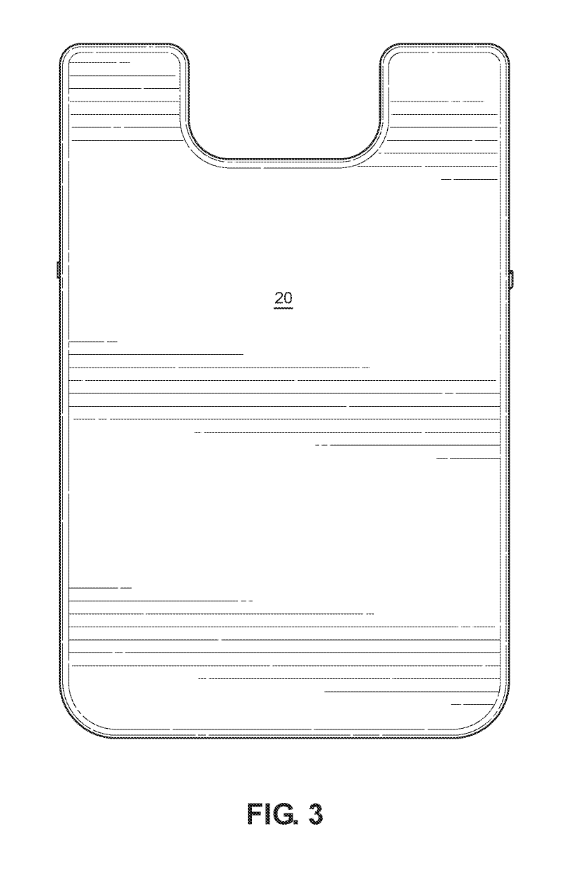

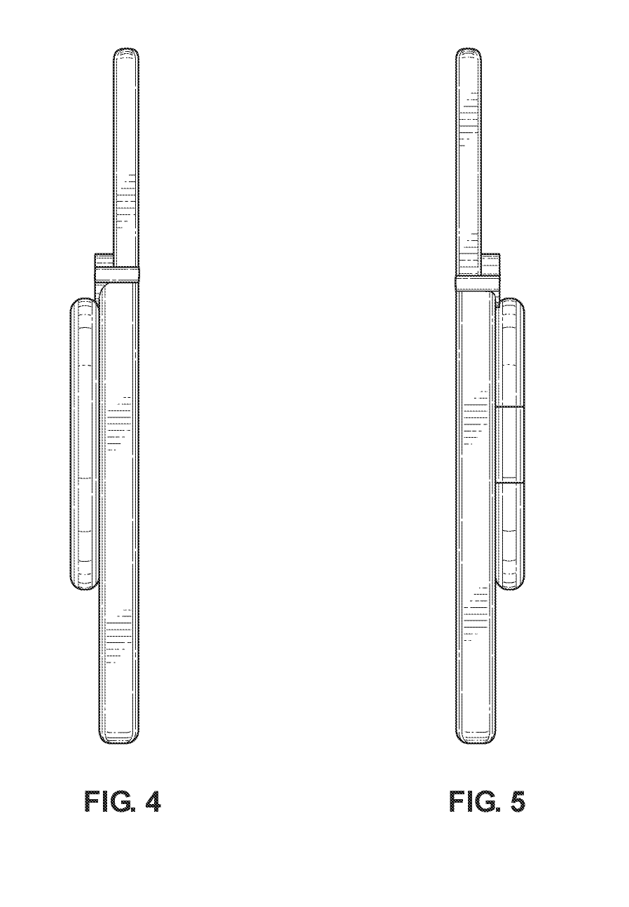

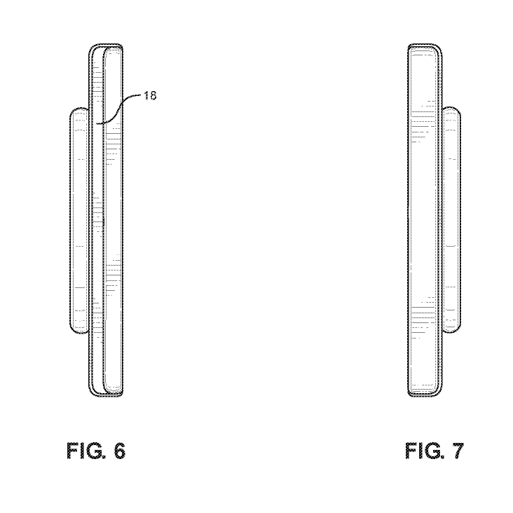

FIGS. 1-7 show a first non-limiting embodiment of the invention. In this embodiment, there is provided a card holder 1 for attaching to a portable device PD (see FIG. 8) that includes an upper end 11, a lower end 12, a left side 13, a right side 14, as well as a front wall 15 and a back wall 16. A notch 17 can be provided in the upper end of the back wall 16. A main opening 18 is provided between the front wall 15 and back wall 16. The opening 18 is sized to receive at least one card and preferably two or three cards which may be debit or credit cards. The back side 16 is configured to be securable to a portable device PD and can include an adhesive layer or backing 20 which can be covered by a removable protective sheet. In use, a user can remove or peel-off the protective sheet to expose the adhesive layer and attach the card holder 1 to a portable device PD, i.e., such as to the back side of the portable device PD or to the case which contains therein the portable device PD. The front wall 15 is configured to receive a ring support/holder RHS which can be either removably or non-removably mounted to the front wall 15.

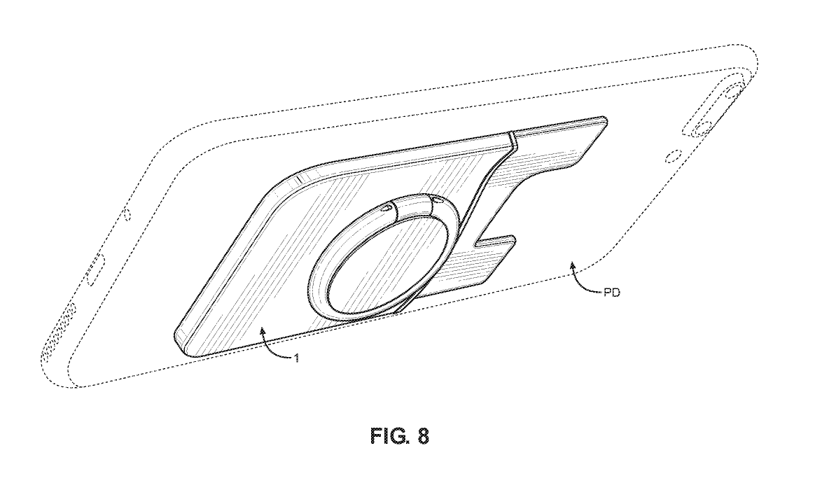

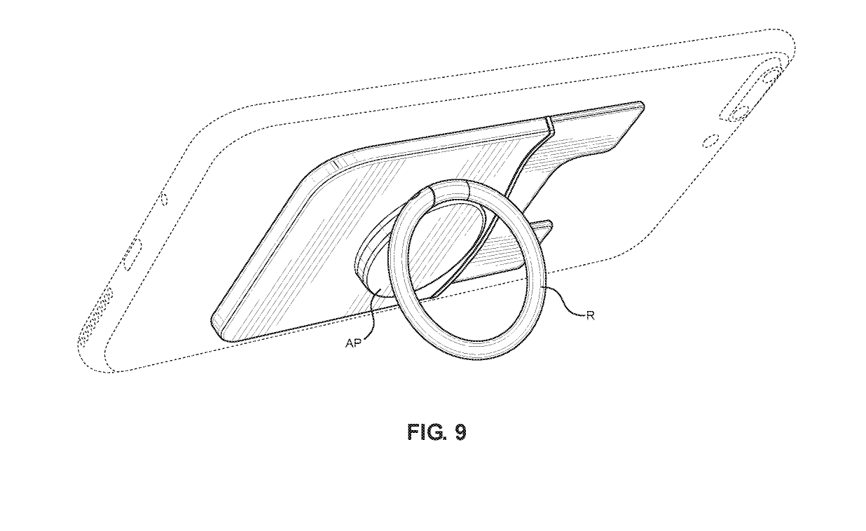

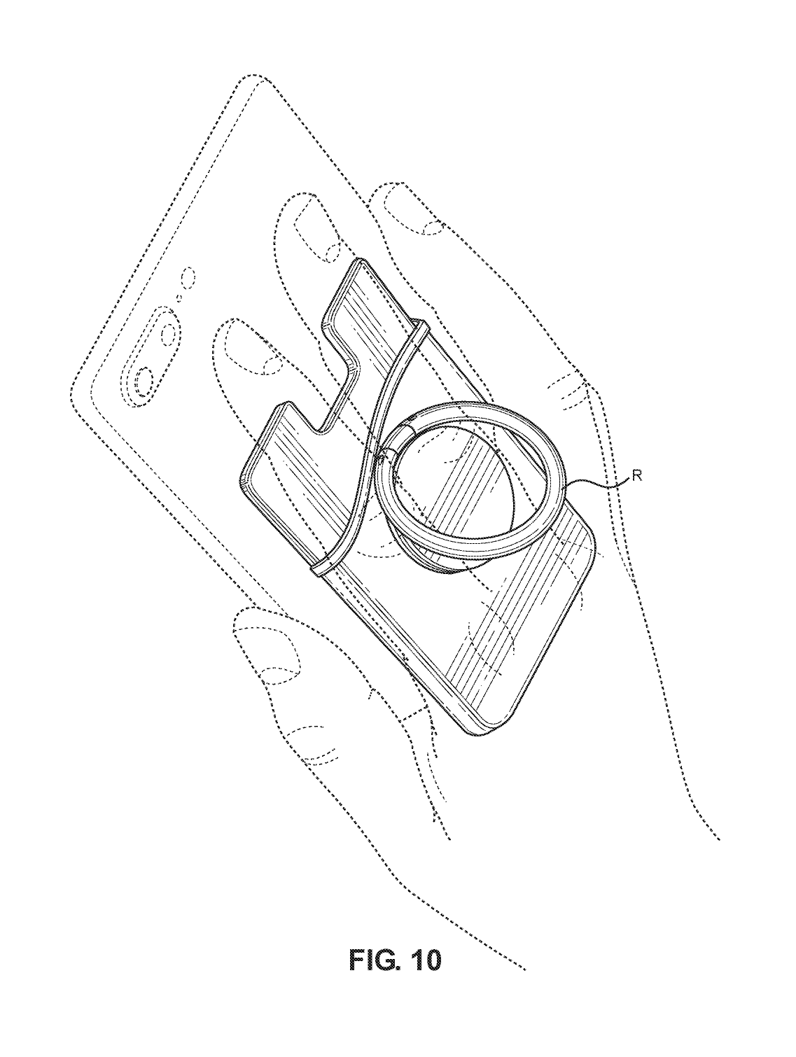

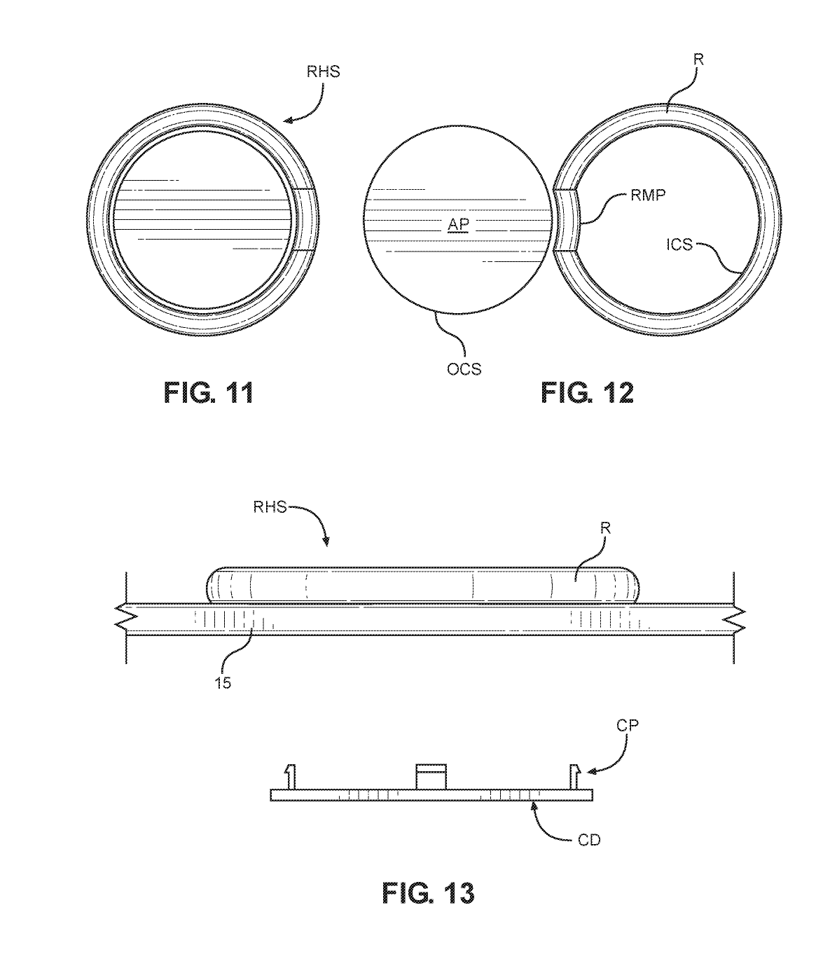

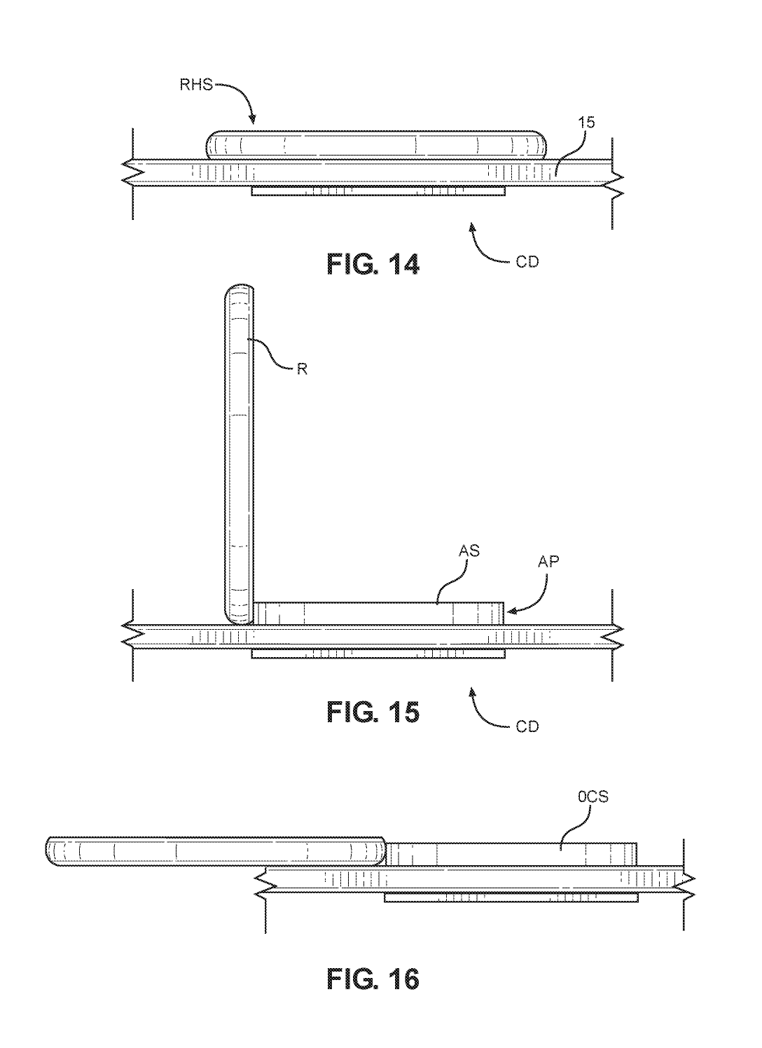

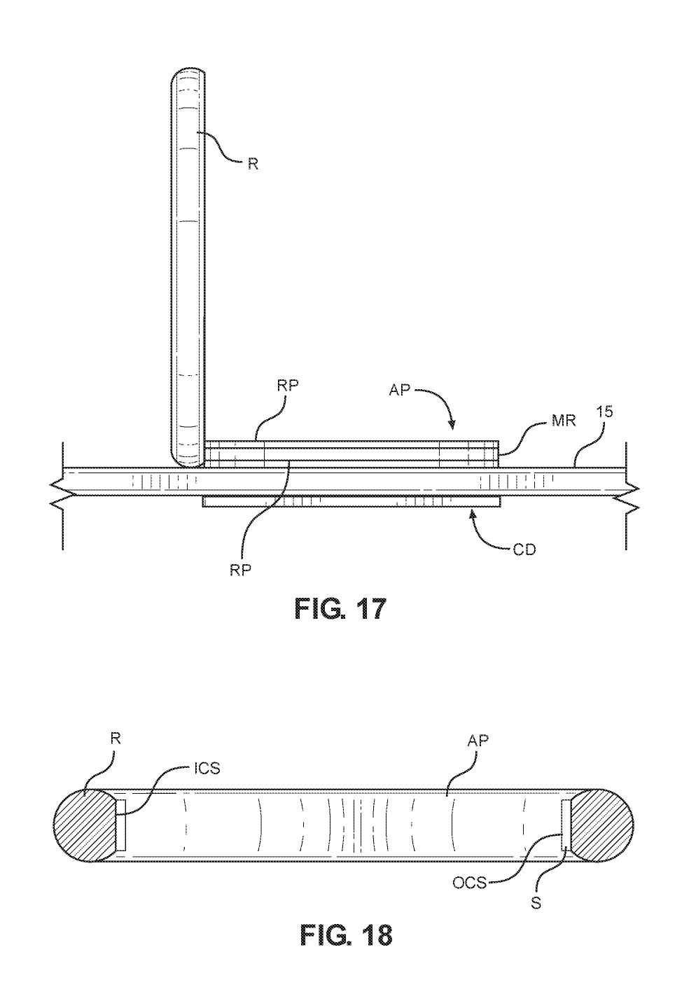

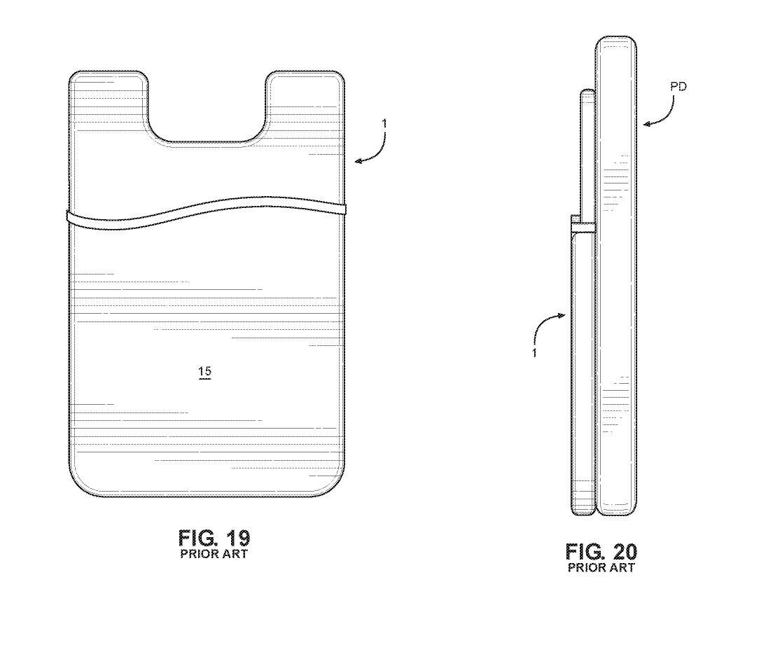

With reference to FIGS. 11-17, it can be seen that the ring holder RHS is configured to be attachable to a card holder 1 such as to the front wall 15. The ring holder RHS includes a main cylindrical attaching portion AP that includes an attachment surface AS. An outer circumferential surface OCS is utilized which can be generally cylindrical. Attaching portion AP has an axial length that is less than a diameter of the outer circumferential surface OCS and preferably less that ¼ of the diameter. A circular ring R is swingable or pivotally mounted to a ring mounting portion RMP of the main attaching portion AP and is capable of moving between an original or retracted position (see FIG. 14) and a pivoted-out or deployed position (see FIGS. 15 and 16), which can be at least between 30 degrees (see e.g., FIGS. 9 and 10) and about 180 degrees (see FIGS. 12 and 16), as well as any angle in-between such as 90 degrees (see FIG. 15). In the retracted position (see FIG. 12), an inner circumferential surface ICS of the ring R surrounds and is disposed adjacent the outer circumferential surface OCS. This surface ICS can be generally cylindrical and can be spaced slightly from the surface OCS by a circumferential space S as shown in FIG. 18. The ring R can retain a pivoted-out position via, e.g., a frictional engagement of a pin P mounting the ring R to the portion RMP. The ring R can also retain a rotational position (about an axis of portion AP) via a frictional engagement between a mounting ring MR and the main cylindrical attachment portion AP (see FIG. 17). The mounting ring MR is located between disc-shaped members RP. When the ring R is in a non-retracted or pivoted out position, the ring R, together with the portion RMP and mounting ring MR can be rotated by a user relative to the fixed disks RP and CD by 360 degrees or more. When one combines the pivoting movement of the ring R between 0 and 180 degrees with the rotational movement of the ring R, one can see that there are a very large number of ways in which a user can position the ring R.

With reference to FIGS. 13 and 17, it can be seen that the ring holder RHS can be attached to a card holder 1 such as to the front wall 15 via a connecting disk CD. The disk CD has protruding projections CP that penetrate the front wall and engage with similarly located receiving recesses formed in the attaching portion AP and which form a locking connection. When fully connected, the disk CD assumes a position similar to that shown in FIGS. 14-17, with the disc CD adjacent and abutting an inner surface of the front wall 15. Alternatively, one can instead use an adhesive connection between the portion AP and the front wall 15 as well as other attachment systems such as hook and loop, rivet, ultrasonic welding, etc.

Non-limiting materials for the card holder 1 include flexible silicone or other types of synthetic resin. Non-limiting materials for the portion AR include metal such as aluminum or one or more types of synthetic resin. Non-limiting materials for the ring R include metal such as aluminum or steel, as well as one or more types of synthetic resin. Non-limiting materials for the disk CD include metal such as aluminum or steel, as well as one or more types of synthetic resin. The invention is not limited to these embodiments. In the context of the invention, different alternatives can be combined with one another, at least partially. The invention also extends to all of the embodiments covered by the appended claims.

### NON-LIMITING EXAMPLES

According to one non-limiting embodiment of the invention, there is provided a ring holder/support RHS that includes an attachable support AR that is securable to a card holder 1 for a portable device PG. The attachable support AP may be attached to a front wall 15 of a card holder 1 while a back wall 16 of the card holder 1 is attached to a portable device PD. The card holder 1 can be sized to hold one or more cards that may be a credit card, debit card, smart card, etc. The portable device PD may be a cell phone, smart phone, or other portable electronic device, etc. In embodiments, the card holder 1 is made of a synthetic resin such as a silicone material. In embodiments, the card holder 1 further comprises an adhesive layer 20 arranged on the back side 16. In embodiments, the card holder 1 further comprises a peel and stick adhesive sheet 20 arranged on the back side 16.

The invention also provides for a ring support/holder RHS attachable to either a portable device PD or a card holder 1 for a portable device PD. The support/holder RHS includes a main attaching portion AR that utilizes an attachment surface, an outer circumferential surface OCS, and an axial length that is less than a diameter of the outer circumferential surface OCS. A ring R is mounted to the main attaching portion AR and is capable of moving between a retracted position to an extended position. In the retracted position, an inner circumferential surface ICS of the ring R surrounds the outer circumferential surface OCS. In the extended position, the inner circumferential surface ICS does not surround the outer circumferential surface OCS. In embodiments, the ring R is swingably or pivotally mounted to the main attaching portion AR. In embodiments, the ring R is swingably or pivotally mounted to the main attaching portion AR via a pin. In embodiments, the ring R is made of metal. In embodiments, the main attaching portion AR is made of metal. In embodiments, the attachment surface of portion AR comprises an adhesive layer configured to secure the attachment surface 20 to the card holder 1 or portable device PD. In embodiments, the ring R is circular and round in cross-section. In embodiments, the main attaching portion AR is generally cylindrical. The ring R has an outer diameter of about 1 inch. In embodiments, the ring R has an inner diameter of about 0.75 inches. In embodiments, the main attaching portion AR has an outer diameter of about 1 inch.

In embodiments, the invention also includes a ring holder RHS attachable to either a portable device PD or a card holder 1 for a portable device PD, wherein the holder comprises a main cylindrical attaching portion AR comprising a planar attachment surface, an outer circumferential surface OCS, and an axial length that is less than a diameter of the outer circumferential surface OCS. A ring R is pivotally mounted to the main attaching portion AR and being capable of moving between a retracted position where an inner circumferential surface ICS of the ring R surrounds the outer circumferential surface OCS and a pivoted-out position. In embodiments, the ring support/holder is attached to a front wall 15 of the card holder 1. In embodiments, the ring support/holder is attachable to a rear side of the portable device PD.

In embodiments, the invention also provides for a ring holder RHS attachable to a card holder 1 for a portable device PD, wherein the holder comprises a main cylindrical attaching portion AR comprising an attachment surface, an outer circumferential surface OCS, and an axial length that is less than a diameter of the outer circumferential surface OCS. A circular ring R is swingable or pivotally mounted to the main attaching portion AR and being capable of moving between a retracted position where an inner circumferential surface ICS of the ring R surrounds the outer circumferential surface OCS and a pivoted-out position.

In embodiments, the invention also provides for a ring holder RHS configured to be attachable to a card holder 1, wherein the holder comprises a main cylindrical attaching portion AR comprises an attachment surface, an outer circumferential surface OCS, and an axial length that is less than a diameter of the outer circumferential surface OCS. A circular ring R is swingable or pivotally mounted to the main attaching portion AR and being capable of moving between a retracted position and a pivoted-out position. In the retracted position, an inner circumferential surface ICS of the ring R surrounds the outer circumferential surface OCS. In embodiments, the axial length is about inches. In embodiments, the axial length is less than ¼ inches.

In embodiments, the invention also provides for a method of making the ring holder/support RHS of any one of the types described above, wherein the method comprises attaching the ring holder/support RHS to either a card holder 1 or a portable device PD.

In embodiments, the invention also provides for a method of using the ring holder/support RHS of any one of the types described above, wherein the method comprises moving the ring R of the ring holder/support RHS from a retracted position to an extended or pivot out position.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

In the devices shown in the drawings, the features are designated as follows:
Ring Holder/Support RHS
Ring R
Cir. Space S
Pin P
Ring mounting portion RMP
Attaching Portion AP
Attachment Surface AS
Mounting ring MR
retaining portions RP
Inner Cir. Surface ICS
Outer Cir. Surface OCS
Connecting disc CD
Connecting projections CP
Portable device PD
Card holder 1
Upper end 11
Lower end 12
Left side 13
Right side 14
Front wall 15
Back wall 16
Notch 17
Card slot 18
Adhesive backing 20

What is claimed:

1. A ring support/holder attachable to either a portable device or a card holder for a portable device, said support/holder comprising:
a main attaching portion comprising:
an attachment surface;
an outer circumferential surface; and
an axial length that is less than a diameter of the outer circumferential surface;
a ring mounted to the main attaching portion and being capable of moving between a retracted position to an extended position,
wherein, in the retracted position, an inner circumferential surface of the ring surrounds the outer circumferential surface; and
wherein, in the extended position, the inner circumferential surface does not surround the outer circumferential surface.

2. The support/holder of claim 1, wherein the ring is swingably or pivotally mounted to the main attaching portion.

3. The support/holder of claim 1, wherein the ring is swingably or pivotally mounted to the main attaching portion via a pin.

4. The support/holder of claim 1, wherein the ring is made of a resin or metal such as aluminum.

5. The support/holder of claim 1, wherein the main attaching portion is made of resin or metal.

6. The support/holder of claim 1, wherein the attachment surface comprises an adhesive layer configured to secure the attachment surface to the card holder or portable device.

7. The support/holder of claim 1, wherein the attachment surface comprises one or more retaining recesses configured to engage with a disc-shaped connecting member having one or more retaining or locking projections.

8. The support/holder of claim 1, wherein the ring is circular and round in cross-section.

9. The support/holder of claim 1, wherein the main attaching portion is generally cylindrical.

10. The support/holder of claim 1, wherein at least one of:
the ring has an outer diameter of about 1 and ⅜ inches;
the ring has an inner diameter of about 1 and 1/16 inches; and
the main attaching portion has an outer diameter of about 1 inch.

11. A ring holder attachable to either a portable device or a card holder for a portable device, said holder comprising:
a main cylindrical attaching portion comprising:
a disc-shaped element;
a planar attachment surface securable to the disc-shaped element;
an outer circumferential surface; and
an axial length that is less than a diameter of the outer circumferential surface;
a ring pivotally mounted to the main attaching portion and being capable of moving between a retracted position where an inner circumferential surface of the ring surrounds the outer circumferential surface and a pivoted-out position.

12. The holder of claim 11, wherein at least one of:
the ring support/holder is attached to a front wall of the card holder; and
the ring support/holder is attached to a rear side of the portable device.

13. A ring holder attachable to a card holder for a portable device, said holder comprising:
a main cylindrical attaching portion comprising:
an attachment surface;
an outer circumferential surface; and
an axial length that is less than a diameter of the outer circumferential surface;
a circular ring swingable or pivotally mounted to the main attaching portion and being capable of moving between a retracted position where an inner circumferential surface of the ring surrounds the outer circumferential surface and a pivoted-out position;
a connecting ring configured to mount the circular ring to the main cylindrical attaching portion.

14. The holder of claim 13, further comprising a disc-shaped element having a snap-engagement connection with the attachment surface, wherein, when installed, a wall on the card holder, the attachment surface and the disc-shaped element are disposed on opposite sides of a wall of the card holder.

15. The holder of claim 14, wherein, when installed, one or more projections connecting the attachment surface to the disc-shaped element extend through the wall of the card holder.

16. A ring holder configured to be attachable to a card holder, said holder comprising:
a main cylindrical attaching portion comprising:
an attachment surface;
an outer circumferential surface; and
an axial length that is less than a diameter of the outer circumferential surface;
a circular ring swingable or pivotally mounted to the main attaching portion and being capable of moving between a retracted position and a pivoted-out position that is at least between 30 degrees and about 180 degrees,
wherein, in the retracted position, an inner circumferential surface of the ring surrounds the outer circumferential surface,
wherein the ring can retain a pivoted-out position via a frictional engagement of a pin mounting the ring to the main cylindrical attachment portion, and
wherein the ring can retain a rotational position via a frictional engagement between a mounting ring and the main cylindrical attachment portion.

17. The holder of claim 16, wherein at least one of:
the axial length is between ⅛ inches and ¼ inches; and
the axial length is less than ¼ inches.

18. The holder of claim 16, further comprising a disc-shaped element having a snap-engagement connection with the attachment surface, wherein, when installed, a wall on the card holder, the attachment surface and the disc-shaped element are disposed on opposite sides of a wall of the card holder and the ring is free to rotate in opposite directions and more than 360 degrees relative to the main cylindrical attaching portion.

19. A method of making the ring holder/support of claim 1, comprising:
attaching the ring holder/support to either a card holder or a portable device.

20. A method of using the ring holder/support of claim 1, comprising:
moving the ring of the ring holder/support from an extended position to an extended or pivot out position.
